(19) United States
(12) Patent Application Publication
(10) Pub. No.: US 2010/0261485 A1
(43) Pub. Date: Oct. 14, 2010

(54) PERSONALIZATION BASED ON USER LOCATION AND HISTORICAL USAGE DATA

(75) Inventor: Cedric Fernandes, San Ramon, CA (US)

Correspondence Address: Weaver Austin Villeneuve & Sampson LLP, P.O. BOX 70250, OAKLAND, CA, 94612-0250, US

(73) Assignee: MobiTV, Inc., Emeryville, CA (US)

(21) Appl. No.: 12/423,519

(22) Filed: Apr. 14, 2009

(51) Int. Cl. H04W 24/00

(52) U.S. Cl. 455/456.3

(57) ABSTRACT

Location information and historical usage data such as historical location data associated with a mobile device is tracked to provide a user with a personalized and location relevant experience. Not only are applications tailored to a particular mobile device location, but applications can be tailored based on user historical location patterns such as commute and travel patterns. Content and applications including content lineup, advertising, mashups, and search are intelligently personalized based on user location and historical location data.

### TECHNICAL FIELD

The present disclosure relates to personalization based on user location and historical location data.

### DESCRIPTION OF RELATED ART

Mobile devices such as cell phones are personal devices, and users of mobile devices expect a personalized experience. Conventional mobile television and general multimedia services available on cell phones are limited in their ability to provide personalized user experiences.

Consequently, it is desirable to provide improved techniques and mechanisms for allowing personalization based on user location and historical location data.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a network architecture that can be used with embodiments of the present invention.

FIG. 2 illustrates one example of a technique that can be used with embodiments of the present invention.

FIG. 3 illustrates one example of converting portions of data, encapsulating these portions in packets, and selecting packets to be delivered to a device.

FIG. 4 illustrates one example of a technique for restricting the delivery of content based on the location of a device.

FIG. 5 illustrates one example of a technique for delivering a weather alert based on the location of a device.

FIG. 6 illustrates one example of a technique for implementing a dating application based on the location of one or more devices.

FIG. 7 illustrates one example of a technique for receiving and processing packets at a mobile device.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular device and network architectures. However, it should be noted that the techniques of the present invention apply to a variety of devices and networks. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Location information and historical usage data such as historical location data associated with a mobile device is tracked to provide a user with a personalized and location relevant experience. Not only are applications tailored to a particular mobile device location, but applications can be tailored based on user historical location patterns such as commute and travel patterns. Content and applications including content lineup, advertising, mashups, and search are intelligently personalized based on user location and historical location data.

### Example Embodiments

Mobile devices such as mobile phones are personalized devices that do not reside in a fixed location. Even though mobile devices are location varying, content and applications provided on mobile devices typically only have limited location based functionality. For example, a user may enter a zip code or a home location and information such as weather reports may be provided based on the zip code or the home location. However, usage of location information is limited.

According to various embodiments, the techniques and mechanisms of the present invention use not only location information but historical location data to provide more personalized applications and content to a user. In particular embodiments, server components generate data consumed by the client application. Inputs from the client application can be used to identify the right data set for the client. As such, the client application leveraging location based service (LBS) application program interfaces (APIs) or using methodologies such as cell tower triangulation can send the user's location to the server. This information together with timestamp data can be stored in a database.

The location information along with timestamp information allows an application and content server to maintain historical user location information. According to various embodiments, the information can be used to create a profile of the user. The location and historical location profile information coupled with real time location information can be leveraged in applications such as advertising, search, content lineup, and mashup.

According to various embodiments, an application and content server supports pre-roll, mid-roll and post-roll advertising. The user's current location as well as historical information can be used to identify the most appropriate advertisement. For example, it may be known that a user walks down a particular street every weekday morning. A product or service offer from a particular store on the street may be provided to the user during weekday mornings on the user's mobile device. In another example, it may be known that a user visits a particular mall every Saturday. Advertising on the user's mobile device may be provided on Friday night to entice the user to visit a store near that particular mall. Advertising may be provided as television commercials, banner advertisements, text advertisements, messages, etc., on the mobile device.

Content lineups may also be tailored based on user location and historical location patterns. According to various embodiments, latitude and longitude coordinates are mapped to geographical regions channel and/or content lineups are generated based on that information. In addition, historical location information can be used to provide an expanded personalized lineup. For example, based on historical location information, a content and application server may learn that a particular user frequently uses the application in the New York area. Based on this information, even if the user is currently in the San Francisco area, the system may choose to generate an expanded lineup with channels and clips showing information about the New York area.

According to various embodiments, mashups showing a map of active user sessions can be generated by leveraging real time location information. In some examples, people within a specific geographic area can interact with each other. In particular embodiments, historical location information is used to determine individuals a user may want to interact with even if the user it currently outside of that particular location.

Search results can also be tailored based on location and historical location data. Search results most relevant to the user's current location or historical location patterns can be displayed at the top of the list. Advertisements associated with search can also be based not only on location but historical location data.

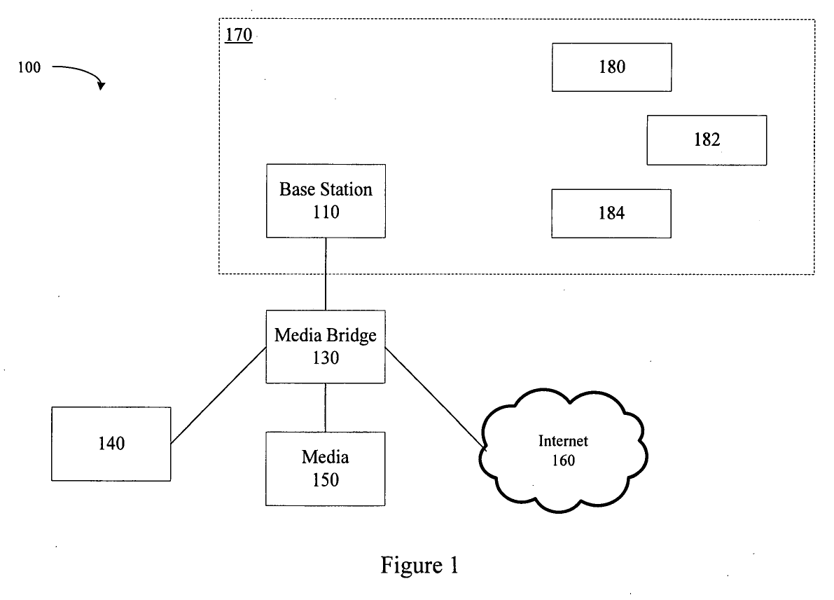

Turning now to FIG. 1, a diagram illustrating the structure of an exemplary communications system for utilization with embodiments of the present invention is shown. As depicted in this figure, this system 100 comprises a media bridge 130 for interfacing between different types of content systems 140, 150, 160 and one or more wireless (or potentially wireline) communication networks 170. Content systems 140, 150, 160 may be broadcast media such as television or radio, other audio or video data, such as a video feed from a DVD player, or the Internet Wireless communication network 170 is in turn composed of base station 110 that is configured to communicate with a plurality of mobile devices (devices) 180, 182, 184. Mobile devices 180, 182, 184 may, for example, be cellular telephones, laptop computers, personal information managers (PIMs or PDA), or the like that are configured for wireless communication. These devices 180, 182, 184 may be running software designed for use with embodiments of the present invention. It should be noted that these devices 180, 182, 184 need not actually be “mobile,” but may simply communicate with base station 110 via a wireline or wireless link. Base station 110 transmits data to mobile devices 180, 182, 184 via corresponding forward link (FL) channels, while mobile devices 180, 182, 184 transmit data to base station 110 via corresponding reverse link (RL) channels.

Users of mobile devices 180, 182, 184 may wish to have content from content sources 140, 150, 160 delivered to them. This may be problematic, however, as delivery of much of this content typically requires large amounts of data to be delivered over a high-reliability highbandwidth connection. Additionally, even if wireless network 170 is such a high-bandwidth network, mobile devices 180, 182, 184 may experience temporary periods of low-bandwidth connection to base station 110, or may be incapable of handling the complexity of such content. Media bridge 130 alleviates these problems by delivering tailored content from content source 140, 150, 160 to each individual mobile device 180, 182, 184.

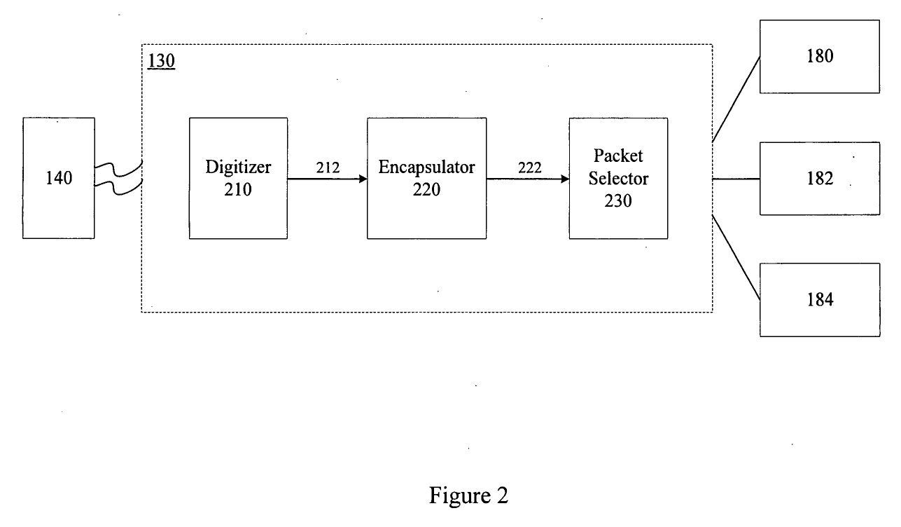

Media bridge 130 may employ embodiments of the present invention to package content from content sources 140, 150, 160 for delivery to mobile devices 180, 182, 184 in a data format which is compact, and simplifies the tasks of decoding and rendering the data format performed by mobile devices 180, 182, 184. Streaming content from a content source 140, 150, 160 is fed into media bridge 130, at which point media bridge 130 may capture and digitize the incoming content if the data is not already in a digital format. This digitized data may be divided up into serialized portions and converted to a wide variety of formats. This data can then be encapsulated in data portions with a certain data format, these data portions encapsulated in packets and a particular series of packets may be sent to base station 110 for delivery to mobile device 180, 182, 184 depending on criteria associated with that particular device 180, 182, 184. It should be noted that the mobile devices 180, 182, 184 and system components in this figure are exemplary and other systems may comprise other types and other combinations of devices. Embodiments of the steps involved in the distribution of data by media bridge 130 are depicted in more detail in FIG. 2. Content coming from media source 140 which is to be delivered to a device 180 may be in an analog format. This analog content, such as a television signal, radio broadcasts or video game data, may be captured using automatic or manual capture methods, and converted to a digital signal (STEP 210). One of ordinary skill in the art will understand the many and varied ways to accomplish this capture and analog to digital conversion (STEP 210). In one embodiment, raw TV signal 140 may be connected to a TV tuner capture card, which in turn captures incoming analog TV signal 140. This analog signal 140 may be converted to a digital signal via the use of a standard analog to digital converter of the type that are well known in the art.

The resulting digital data 212 may be converted to a variety of formats and encapsulated in packets (STEP 220) in order to facilitate delivery of data 212 to device 180. Packets of this data 222 may then be selected for delivery (STEP 230) to device 180 based upon a set of criteria.

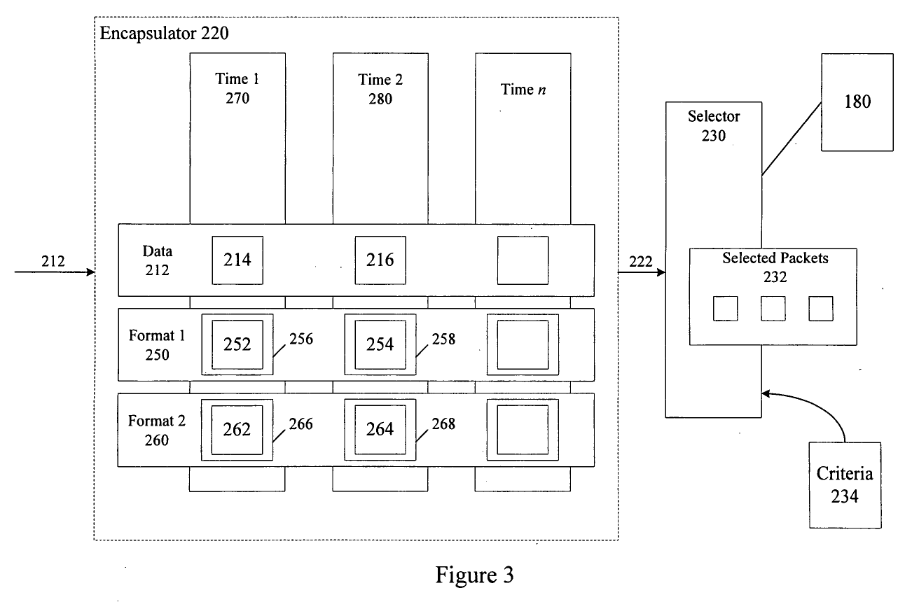

Moving now to FIG. 3, embodiments of the process for encapsulating data (STEP 220) are depicted in greater detail. Encapsulation process (STEP 220) may in turn include separating original data 212 into portions 214, 216 and converting those portions 214, 216 into a variety of different formats 250, 260. The resulting data portions 252, 254, 262, 264 of data in different formats 250, 260 cover time periods 270, 280 corresponding to portions 214, 216 of original data 212. In other words, a portion (chunk) 252 of data in one format 250 covers the same time period 270 of original data 212 as corresponding portion 262 in another format 260.

To elucidate more clearly, if incoming original data 212 is digitized video data, original data 212 may be divided into portions 214, 216 which cover the first 20 seconds of the video represented by original data 212, with one portion 214 representing the first 10 seconds (time period one 270) and another portion 216 representing the second 10 seconds (time period two 280). Portions 214, 216 may then be converted to two different formats 250, 260. The resulting data portions 252, 262 corresponding to original portion 214 represent the same first 10 seconds (time period one 270) of original data 212, albeit in two different formats 250, 260. Similarly, data portions 254, 264 corresponding to original data portion 216 represent the second 10 seconds (time period 2 280) of original data 212 in two different formats 250, 260.

Additionally, during this conversion process each portion 252, 254, 262, 264 of the data may be augmented. For example, information regarding closed captioning may be added to a portion of video data represented in the MPEG format, billing information may be added to a portion of a web page represented in HTML, Java content may be added to a portion of the data to provide interactive controls to users of mobile device 180, etc. These portions 252, 254, 262, 264 of data may also be optimized for delivery to a device 180 through the use of compression algorithms and the like. After original data 212 is separated into portions 214, 216 and converted into different formats 250, 260, the resulting data portions 252, 254, 262, 264 may then be encapsulated in packets 256, 258, 266, 268 for delivery to device 180. Typical file formats for the encapsulation of data include layers dedicated to transmission protocols, application protocols, payload formats, and content formats. In many cases, data portions 252, 254, 262, 264 may be larger than may be placed in the payload of various types of packets 256, 258, 266, 268.

In cases such as these, a data portion 252, 254, 262, 264 may be split across multiple packets 256, 258, 266, 268, such that more than one packet 256, 258, 266, 268 may be utilized to deliver a single data portion. In some embodiment, by utilizing reliable data transport protocols such as TCP/IP to deliver packets 256, 258, 266, 268 to a device 180, the in order delivery of packets 256, 258, 266, 268 comprising a portion of data 252, 254, 262, 264 at an application or device may be substantially guaranteed. By utilizing data portions 252, 254, 262, 264 that may be bigger than packets 256, 258, 266, 268 a higher effective data rate may be achieved. Additionally, it may foist processing and ordering duties onto lower levels of a protocol stack, which may be more efficient at these duties than higher level layers of the protocol stack.

In addition to allowing data portions to be tailored for various devices, augmented, compressed etc., the data format of data portions 252, 254, 262, 264 could also be used to deliver commands to the devices 180, 182, 184 which are to process, control, and render the data contained within those packets 256, 258, 266, 268. In one embodiment, the various portions of data 252, 254, 262, 264 may be a data format which allows the efficient encapsulation, transmission, reception, and decomposition of heterogeneous data. A data portion 252, 254, 262, 264 may contain commands which have identical easy to decode structures, and which may be evaluated and executed in the order in which they are encoded, greatly simplifying the evaluation and execution of the commands, the encapsulation of portions 252, 254, 262, 264 in packets 256, 258, 266, 268, the delivering of packets 256, 258, 266, 268 to device 180, and the rendering of the data contained within a data portion 252, 254, 262, 264 by device 180.

More specifically, during encapsulation (STEP 220), each portion of data 252, 254, 262, 264 is evaluated to produce a set of commands, which when executed in a certain order are operable to instruct a decoding or rendering device to present the respective portion of data 252, 254, 262, 264. This set of commands can then be concatenated to form the respective data portion 252, 254, 262, 264. The set of commands of a data portion 252, 254, 262, 264 may then be encapsulated into one or more packets 256, 258, 266, 268 for delivery to device 180. All commands may have the same structure, and the order of command evaluation or execution may be determined by the order in which the commands are concatenated (and possibly the side effects of the evaluation). Each command may in turn be composed of a tag or command identifier, a length indicator and a data payload. Thus, if a data portion 252, 254, 262, 264 is delivered using multiple packets 256, 258, 266, 268 it makes little differences where the set of commands comprising the data portion 252, 254, 262, 264 is split or divided for inclusion in the payload of packets 256, 258, 266, 268, if a reliable protocol is to be utilized to deliver packets 256, 258, 266, 268.

According to various embodiments, systems for interacting with devices based on the location information and historical location information are provided. Embodiments of these systems and methods may allow a content delivery device or system to provide certain content to, or restrict certain content from being delivered to, a device based on the location of the device to be evaluated when a channel is requested by the mobile device. For example, a user at a device may request certain content; the location of the device may then be compared against an access control list defining a set or rules regarding the content to determine if the requested content may be accessed from, or is suitable for, that location. If the content may be accessed from this location the content may be delivered, otherwise an error message, or other options, may be delivered to the device. Similarly, content may be delivered to a certain device based on the location of the device. For example, a user at a device may request certain content and, based on the location of the device, content appropriate to that location may be delivered to the device.

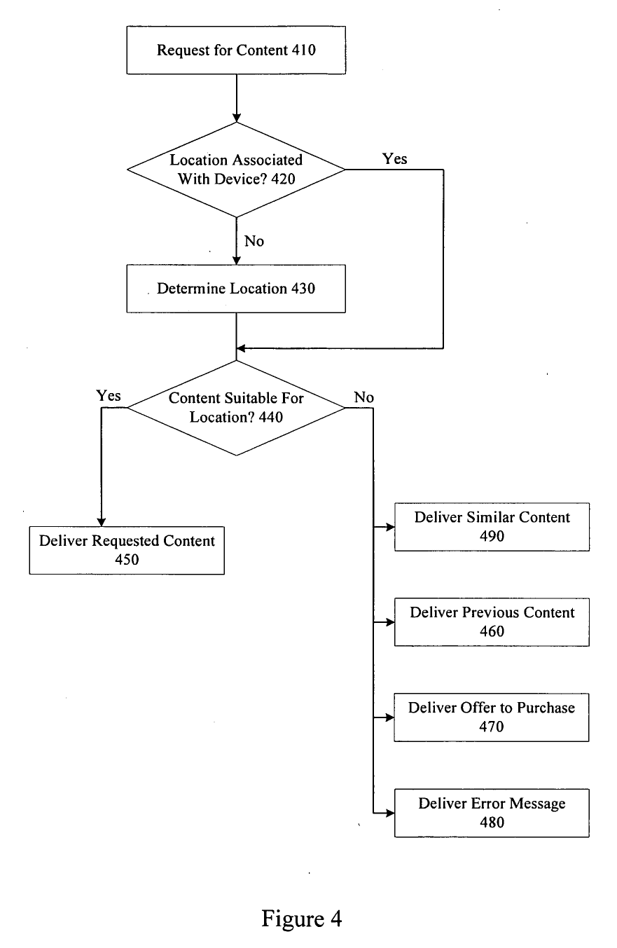

Turning now to FIG. 4, a flow diagram for one embodiment of a technique for location based content restriction is depicted. At step 410 a user at device 180 may send a request for content to a content delivery system operable to deliver content to device 180, such as media bridge 130. This request may include, for example a request to receive content corresponding to a channel of a television or radio broadcast, a particular application, etc. This request may, in turn, be received at the content delivery system (e.g. in one embodiment media bridge 130) operable to deliver content to the device 180.

Upon receiving the request it may be determined, at step 420, if a location is associated with the device 180 from which the request originated. More specifically, in certain embodiments, when a media player is installed on device 180 operable to play content delivered from media bridge 130 or a device is registered with a service such that content may be provided from media bridge 130 to the device, a unique identifier (e.g. a number unique with respect to all devices which may receive content from media bridge 130) may be assigned to the media player or the device 180. Media bridge 130 may keep a table in storage of the unique identifiers and a corresponding location associated with that unique identifier.

In one embodiment, whenever a device 180 is powered on and a media application on the device activated, the media application may register its unique identifier with media bridge 130 and its location, such that media bridge 130 may maintain a table of active devices (e.g. unique identifiers of the active devices) and locations associated with the active devices. Additionally, the location may be updated at a certain interval, either by prompting from media bridge 130 or by the media application on the device 180.

Alternatively, in one embodiment, the unique identifiers of active devices are stored, but a location for a device may not be automatically registered or updated by the device 180. In this case, at step 420 a determination may be made if there is a location associated with the device from which the request was sent (or, for example, the currency of the associated location is outside a certain time window). If there is no location associated with the unique identifier of the device which initiated the request, or the location associated with the unique identifier has garbage values, the location of the device may be determined at step 430.

In one embodiment, media bridge may send one or more instructions to device 180 such that device 180 may perform a set of actions to determine its location and return this location to media bridge 130. Particularly, in one embodiment, the device 180 (or the operating system of the device) may provide an Application Programming Interface (API) call from which a location such as a latitude and longitude may be determined. Thus, the instruction sent from media bridge 130 may instruct the media application on the device to use an API call to obtain the latitude and longitude of the device and return the latitude and longitude to media bridge 130.

Many devices, however, do not provide such API calls. For these types of devices, the set of instructions sent from media bridge 130 may instruct the media application on the device to make a request based on a certain protocol (e.g. Hyper Text Transfer Protocol or HTTP) to a gateway associated with a provider of service for the device (e.g. a gateway associated with base station 110). A response to this request from the gateway may include a header and metadata pertaining to the request, response, device, etc. By parsing the header of the response to the request, the latitude and longitude of the requesting device may be determined and this latitude and longitude returned to media bridge 130. In another embodiment, this HTTP request is directed to a server coupled to the gateway. The gateway may append a location request to the original HTTP request such that the server receives the original request and the location request. The server may then return the location information pertaining to the device to the gateway, which returns this location information to the device, by for example, placing the location information in a header of an HTTP response. It will be apparent that the determination of the location of the device at step 430 may be accomplished in a variety of methods, and an appropriate methodology may be selected or utilized based on factors associated with a particular implementation of an embodiment of the invention such as the capabilities of the particular device, the carrier network on which the device is running, etc. For example, certain devices may have an internal Global Positioning System (GPS) locator. Where an antenna inside of that device may pick up GPS signals and the device does GPS decoding, such that a location of the device may obtained in this manner. In another embodiment, the device may make a request for its location from a network with which it interfaces or the network may determine the location of the device using triangulation based on signal strength. In still other embodiment, the location of the device may be stored on the device, such that the location can be accessed and reported to media bridge 130, etc.

Referring still to FIG. 4, once the location has been determined and returned to, or obtained by, media bridge 130 it may be associated with the unique identifier for the device. As described above, however, this location information may comprise a longitude and latitude. When determining a location at step 430, then, it may be desired to associate the latitude and longitude of a device with one or more geographical regions, where the geographical regions may correspond to certain geographically defined features, such as a postal zip code, city limits, a congressional district, etc. These geographical regions may be defined by a polygonal space where the vertices of the polygon are defined by a latitude and longitude (e.g. media bridge may maintain a database of regions defined by a set of vertices). Thus, it can be determined if the latitude and longitude returned by the device lies on, or within, the geographical region defined by the vertices of the polygon, and a corresponding geographical region identified for the device. This geographical region may then be associated with the unique identifier for the device in lieu of, or in addition to, the latitude and longitude of the device. It will be apparent that more than one geographical region may be identified and associated with a particular device, for example a device may be associated with a particular postal zip code and city.

It should also be noted that other methods may be utilized to assign a user to a geographic region. For example, geographic regions may have a centroid (e.g. a two-dimensional center) that can be specified in latitude/longitude coordinates. Thus, in this case, media bridge 130 may store a table of region-centroid pairs. A region can then be associated with the unique identifier of a device by assessing which centroid is closest to a latitude and longitude of the device. Additionally, if the distance from the device from the nearest centroid (e.g. distances between points represented by respective latitude and longitudes) is greater than some configurable threshold it may be determined that the device (e.g. unique identifier for the device) should not be associated with that region or possibly any other region.

Once the location of the device has been determined, or obtained, it may be determined at step 440 if the content requested by the device may be delivered to the device based on the current location of the device. In one particular embodiment, content which may be delivered by media bridge 130 to various devices may be associated with a default rule and an access control list. The default rule may be a default access for the associated piece of content, for example a default of available may mean that this content may be delivered barring any exceptions to the default rule, while a default rule of restricted may indicate that the content is not to be delivered unless an exception to the default rule exists.

An access control list associated with the content may include a set of exceptions to the default rule for the content. In particular, the access control list may comprise a set of geographical regions or sets of latitude and latitudes which comprise a set of exceptions to the default rule for the associated content. In other words, if the default rule for the content is available, the set of exceptions may indicate geographical regions where the content is not to be delivered at that time. Conversely, if the default rule for the content is restricted the set of exceptions may indicate geographical regions where the content may be delivered at that time.

As the rules pertaining to he access of various content may change quite rapidly according to a variety of conditions or criteria and an explicit rule for each piece of content with respect to multiple regions may be a very long list to manage and parse, an access control list coupled with a default rule may be easier to update and thus allow for greater ability to dynamically adjust the availability of a piece of content to a device. More specifically, an access control list with a default rule may allow for management by exception when defining content access rights. Exceptions to the default rule may be defined instead of explicitly indicating for each possible region whether or not access to content is, or is not, allowed.

Based on an evaluation of a default rule and access control for the requested content, then, it can be determined, at step 440, if the requested content should be delivered to the device. If the determination is made that the requested content can be delivered to the device, media bridge 130 may sequence delivering the requested data to the device at step 450.

If, however, it is determined that the requested content should not be delivered to the device (e.g. the device is in a location to which the requested content should not be delivered) media bridge 130 may take a variety of actions, a sampling of which are depicted in the embodiment of FIG. 4.

Namely, media bridge 130 may deliver content that was previously being delivered to the device before the device issued the request at step 460, or media bridge 130 may deliver new content (which is not the requested content) similar to the requested content (e.g. a N.Y. Mets game instead of the requested Yankees game) at step 490. Alternatively, an offer to purchase the requested content, along the lines of a pay per view arrangement, may be delivered to the device at step 470. Media bridge 130 may also deliver an error message to the device notifying the user of the device that the requested content cannot be delivered to the device at step 480.

As can be seen from the above description of embodiments of the invention, the delivery of content to a user may be restricted based on the location of the user's device. However, once a location for a device is obtained or known, almost any type of content sent to a device may then be tailored to the location of the device. In other words, restriction of the delivery of certain content based on the location of the device is only a microcosm or embodiment of the systems and methods of the present invention, which are also capable of delivering content to a device based on the location of the device.

Tailoring the content delivered to a user, or a user experience to the location of a user is highly desirable. In the past, a user at a device, such as a computer surfing the Internet may have navigated to a certain site which requests the location, city, zip code of a user. When or if the user gives the web site some location information about his location, it can remember that information and use it later on to customize your experience. So, for example, with “Craig's List”, if a user informs the web site that the location is Austin, the web site will give the user the listings for the Austin area. However, with these types of systems there is no ability to do customization of the content delivered to a user of a device based on a determination of the location of the device, for example autonomously delivering a piece of content based upon d he occurrence of an event unrelated to the user.

The wide degree of usefulness and applicability of embodiments of the systems and methods of the present invention may be better illustrated with reference to a particular example. For instance, delivering a weather alert to a user based on the location of the user (e.g. the user's device) without any request or interference from the user.

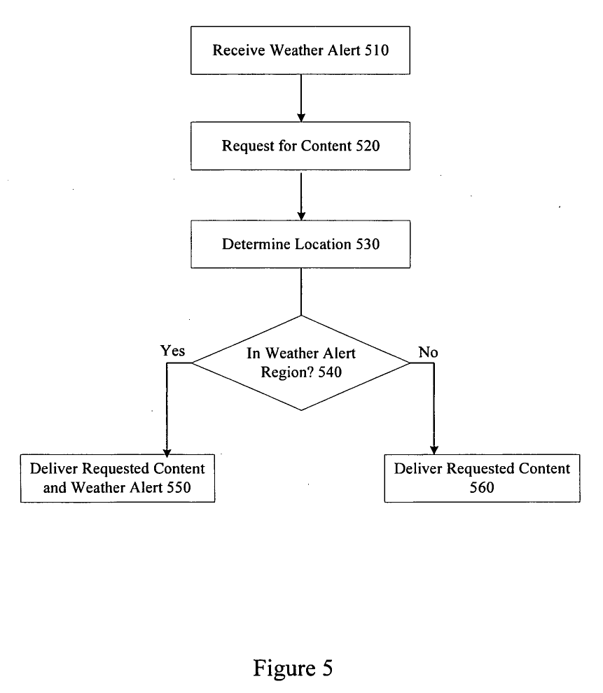

Moving now to FIG. 5, a flow diagram for one embodiment of a weather application for giving weather alerts to users of devices is depicted. The steps for this embodiment may be implemented, for example, by software instructions comprising a weather alert module running on media bridge 130. At step 510 a weather alert for a certain region may be received at media bridge 130 from a weather service, etc. This weather alert and regions associated with this weather alert may be stored. Thus, a database may exist with a set of outstanding weather alerts and regions associated with each of the weather alerts.

At step 520 a request for content may be received from a device. The location of the device may then be determined at step 530, as discussed above with respect to FIG. 4. More particularly, one or more regions in which the device is located may be stored on media bridge 130 or may be determined upon receiving the request. The location (e.g. regions) of the device may then be compared against the regions or locations associated with the weather alerts at step 540 to determine if the device is in a location or region for which a weather alert has been issued. If the determination is made that the device is in such a location, a weather alert may be sent to the device along with the requested content at step 550, while only the content itself may be delivered at step 560 if the device does not lie within such a region or location. It will be apparent that certain steps of the embodiments depicted in FIG. 5 (and the other Figures as well) may not occur in other embodiments. For example, the received weather alert may be delivered to all devices associated with the region for which the weather alert was issued irrespective of whether a request for content (STEP 520) has been received from a device. In other words, the weather alert may be a delivered to a device autonomously (e.g. without involvement of the device) by a content delivery system or device. The same sort of methodology depicted with respect to the embodiment of FIG. 5 can be utilized for a whole host of applications operable to deliver content to a device based on the location of the device, where the content may be apropos, or related to, the location of the device.

For example, traffic information may be delivered to the user of a mobile device based on the location of the mobile device, or the local affiliate of a nationwide broadcast network delivered to a user based on his location, etc. More commercially oriented applications may also be implemented. For example, advertising may be targeted and delivered to a user based on the location of the user's device. For example, at some point during the delivery of content to a device it may be desirable for media bridge 130 to deliver an advertisement or commercial to the device. A commercial to be delivered to the device may be chosen by media bridge 130 based on the location of the device and thus different ads may be delivered to users at devices based on the location of each of the devices, even though each of the users may be viewing the same (or different) content.

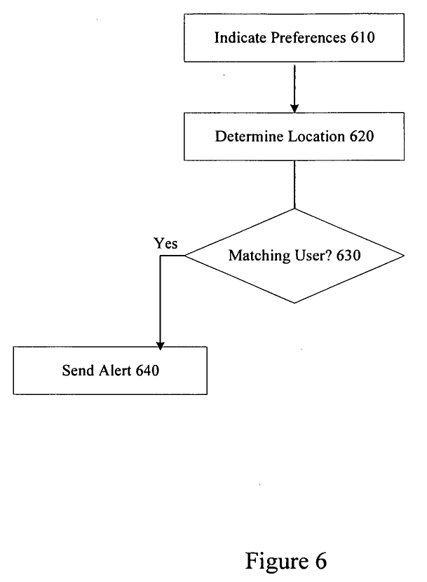

The location of a device may also be used to spur or trigger interaction between users of devices located in the same region or regions in close proximity to one another. FIG. 6 depicts a flow diagram of one embodiment of a dating application for linking users of devices in the same region or regions in close proximity to one another. Again, the steps for this embodiment may be implemented, for example, by software instructions comprising a dating module running on media bridge 130.

At step 610 a user of a device may indicate his dating preferences (e.g. sex, body type, religion etc.). These preferences may be sent to media bridge 130, where they may be stored and associated with the unique identifier corresponding to the device (discussed above). At step 620 the location of the user's device can then be determined, as discussed above with respect to FIGS. 4 and 5. A determination can then be made at step 630 if another user (e.g. device or unique identifier) associated with similar or matching results is located with the same region, or a region within a certain distance of the region in which the user is located. If a matching user is located within a certain proximity of the user an alert may be sent to the user's device at step 640, where the alert may be a notification that a potential match is in the vicinity and an invitation to anonymously contact the matching user, etc. It will be apparent that, in some embodiments the determination at step 630 may be made at certain intervals, and that similar embodiments may be utilized for other purposes than dating, for example notification of designated friends in close proximity, family members, etc.

In addition to the above described embodiments of delivering content to a user based on the user's location, it will be apparent that similar methodologies may be used for other embodiments of the present invention which may deliver almost any type of content selected based on the location of the user. Some examples: embodiments of the present invention may be used for gaming. Specifically, a variety of users in proximity to one another be notified that they are playing the same game and asked 10 play interactively. Additionally, the physical location of one or more of the users may actually be used to affect the gaming experience itself. For example, the landscape in a game being played on a device may reflect the landscape of the location where the user of the mobile device is located. In one embodiment, a game may be written with a set of virtual landscapes. When the user is playing the game the location of the user's device may be determined and the gaming content delivered to the user by media bridge 130 may be selected based on the location of the device.

It will also be apparent that a variety of methodologies may be utilized for restricting or delivering content to one or more devices based on the location of these devices. In one particular embodiment, there may be a set of modules on media bridge 130 these, each module responsible for implementing a particular application. For example, one module may implement location based channel restriction, while one module may implement a dating application and yet another module may implement a gaming application etc. In this way the needs of a whole host of users may be met.

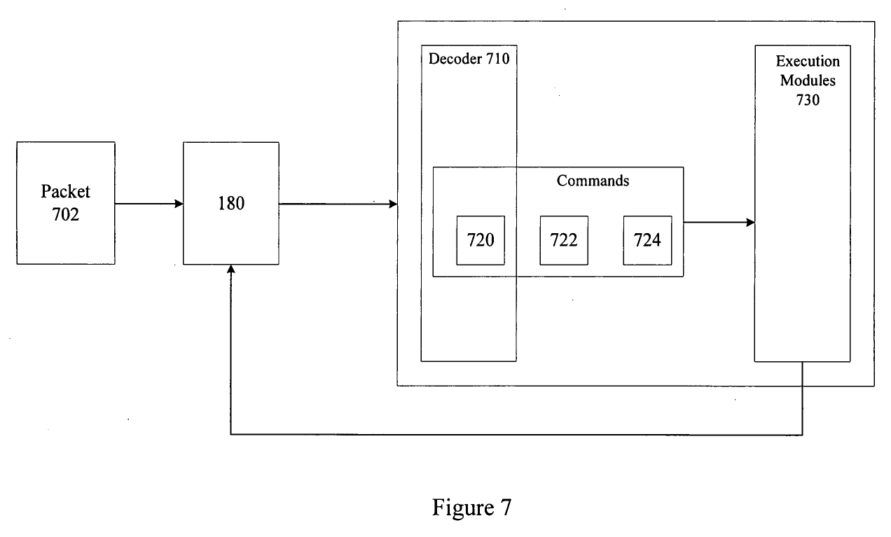

After content, or packets thereof, are selected for delivery to a device, these packets may be sent to the device, where they are received and processed. Turning to FIG. 7, an embodiment of the reception and processing of packets 232 by a mobile device is depicted. Mobile device 180 may receive packet 702 from media bridge 130 via base station 110. Decoder 710, on mobile device 180, may then extract each command 720, 722, 724 encapsulated in packet 702. In one embodiment, packet 702 may be in the data format described above where each command 720, 722, 724 is composed of a single character command identifier, followed by a 12 digit (zeroprefixed) length, followed by a data payload which is of this length. Decoder 710 identifies an encapsulated command 720, 722, 724 by identifying a tag and a corresponding payload using the length element of each command 720, 722, 724.

Decoder 710, on mobile device 180, may also receive command 720, 722, 724 encapsulated in packet 702. In one embodiment, a lower level protocol layer may extract commands 720, 722, 724 from packet 702 and present these commands to decoder 710. As discussed above, if multiple packets are utilized to deliver a portion of data, this portion may be assembled from the multiple packets by a lower level protocol layer and presented to decoder 710 such that decoder 710 receives a complete data portion in the data format described above.

For each command 720, 722, 724, decoder 710 may perform a corresponding action. In one embodiment, decoder may identify the type of command 720, 722, 724 using the associated tag. This command may then be passed to one of execution modules 730 based on the type of command 720, 722, 724.

In one particular embodiment, decoder 710 on mobile device 180 is implemented as a finite state machine which evaluates commands 720, 722, 724 based on the order in, which commands 720, 722, 724 are encapsulated in packet 702 or are presented to decoder 710. For each command 720, 722, 724, decoder 710 may identify the type of command 720, 722, 724 using the associated command tag. If the decoder is able to execute command 720, 722, 72, it may pass command 720, 722, 724 to one of a set of execution modules 730, where command 720, 722, 724 may be executed and the state of mobile device 180 altered accordingly. When decoder 710 encounters a command 720, 722, 724 which it does not know how to evaluate decoder 710 may skip the remaining portion of this command using the length portion of the command to determine the start of the next command. By skipping unknown commands new command types may be added to a data format while still allowing legacy devices to process the data format.

It will be apparent that because embodiments of the data format discussed allow commands to be executed in the order encountered, a command may decoded and passed to an execution module for execution. During execution of this first command a second command may be decoded. This allows commands to be decoded and rendered more efficiently. For example, command 724 may be decoded and passed to execution modules 730 for execution. Simultaneously with the execution of command 724 decoder 730 may be in the process of decoding command 722.

However, as may be imagined, circumstances associated with device 180 may be substantially constantly variable, such that in some cases a large amount of data may be received by device 180, while in other situations relatively little data may be received by device 180. This can cause problems with a multimedia player (e.g. a software application including a decoder and set of execution modules) on device 180. When a large amount of data is received by device 180 a multimedia player may receive portions (e.g. sets of commands) faster than it can decode and execute the commands. Thus, a multimedia player may need to store these portions before they may be executed. If the condition persists to long, the amount of data received may require a large storage capacity. Conversely, if little data is received for a lengthy period, the multimedia player may run out of data to render, causing glitches in the presentation of data to a user of the device.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method, comprising:
receiving first location information for a mobile device, the first location information associated with a first timestamp;
receiving second location information for the mobile device, the second location information associated with a second timestamp;
generating a historical location information profile for the mobile device, the historical location information including the first location information associated with the first timestamp and the second location information associated with the second timestamp;
providing content tailored to the mobile device historical location information profile.

2. The method of claim 1, wherein content comprises advertising targeted to the historical location information profile of the mobile device.

3. The method of claim 1, wherein content comprises channel lineups targeted to the historical location information profile of the mobile device.

4. The method of claim 1, wherein content comprises mashups targeted to the historical location information profile of the mobile device.

5. The method of claim 1, wherein content comprises search results targeted to the historical location information profile of the mobile device.

6. The method of claim 1, wherein content is tailored based on commute and travel patterns associated with the mobile device.

7. The method of claim 1, further comprising determining that the mobile device is located in an area corresponding to the second geographic location.

8. The method of claim 7, further comprising providing content associated with a third geographic location to the mobile device based on the historical local information profile of the mobile device.

9. A device, comprising:
an interface operable to receive first location information for a mobile device, the first location information associated with a first timestamp and receive second location information for the mobile device, the second location information associated with a second timestamp;
a processor operable to generate a historical location information profile for the mobile device, the historical location information including the first location information associated with the first timestamp and the second location information associated with the second timestamp;
wherein content tailored to the mobile device historical location information profile is provided to the mobile device.

10. The system of claim 9, wherein content comprises advertising targeted to the historical location information profile of the mobile device.

11. The system of claim 9, wherein content comprises channel lineups targeted to the historical location information profile of the mobile device.

12. The system of claim 9, wherein content comprises mashups targeted to the historical location information profile of the mobile device.

13. The system of claim 9, wherein content comprises search results targeted to the historical location information profile of the mobile device.

14. The system of claim 9, wherein content is tailored based on commute and travel patterns associated with the mobile device.

15. The system of claim 9, wherein the processor is further operable to determine that the mobile device is located in an area corresponding to the second geographic location.

16. The system of claim 15, wherein content associated with a third geographic location is provided to the mobile device based on the historical local information profile of the mobile device.

17. A system, comprising:
means for receiving first location information for a mobile device, the first location information associated with a first timestamp;
means for receiving second location information for the mobile device, the second location information associated with a second timestamp;
means for generating a historical location information profile for the mobile device, the historical location information including the first location information associated with the first timestamp and the second location information associated with the second timestamp;
means for providing content tailored to the mobile device historical location information profile.

18. The system of claim 17, wherein content comprises advertising targeted to the historical location information profile of the mobile device.

19. The system of claim 17, wherein content comprises channel lineups targeted to the historical location information profile of the mobile device.

20. The system of claim 17, wherein content comprises mashups targeted to the historical location information profile of the mobile device.
